(19) United States
(12) Patent Application Publication
(10) Pub. No.: US 2008/0076423 A1
(43) Pub. Date: Mar. 27, 2008

(54) HANDOVER METHOD AND APPARATUS USING HANDOVER HISTORY

(75) Inventors: Keun-jae LEE, Suwon-si (KR); Sang-su NAM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/743,165

(22) Filed: May 2, 2007

(30) Foreign Application Priority Data
Sep. 27, 2006 (KR) 10-2006-0094339

(51) Int. Cl. H04Q 7/20

(52) U.S. Cl. 455/436

(57) ABSTRACT

A handover method and apparatus are provided. The handover method of a mobile station (MS) moving from a network of a first access point (AP) to a network of a second AP includes scanning the second AP through a specific channel according to a handover history registered in the MS; and associating the MS with the second AP according to a result obtained from the scanning. Accordingly, a time delay occurring in the process of scanning an AP is minimized, thereby avoiding data loss of a service requiring real-time based data transmission.

### CROSS-REFERENCE TO RELATED PATENT APPLICATION

This application claims priority from Korean Patent Application No. 10-2006-0094339, filed on Sep. 27, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a handover, and more particularly, to providing fast access point scanning when a handover is performed in a wireless local area network (WLAN) environment.

2. Description of the Related Art

The rapid growth in mobile communication service subscribers and the growth in mobile communication services supporting multimedia communication have created a demand for seamless communication services for a user on the move. Accordingly, a handover performed in a WLAN environment becomes very important.

FIG. 1 illustrates a handover scenario in a related art WLAN environment.

Referring to FIG. 1, the WLAN environment includes a mobile station (MS) 10, a first access point (AP) 11, a second AP 12, an access router (AR) 13, and a correspondent node (CN) 15.

The MS 10 moves from a network managed by the first AP 11 to another network managed by the second AP 12. The networks managed by the first and the second APs 11 and 12 are each referred to as a basic service set (BSS). The BBS includes a unique service set identifier (SSID) and a basic service set identifier (BSSID).

The first AP 11 and the second AP 12 are connected to the AR 13, thereby relaying communication between the MS 10 and the CN 15 through a wire network 14, that is, the Internet.

As the MS 10 moves from the network of the first AP 11 to the network of the second AP12, the MS 10 is disconnected from the first AP 11 and attempts to connect with the second AP 12. This is called a handover.

A handover of the MS 10 is performed by means of an AP scanning process, an authentication process, and an association process. According to experiments, it has been known that a time delay occurring in the above processes is mostly produced in the AP scanning process.

FIG. 2 illustrates a related art AP scanning method.

In the WLAN environment, two AP scanning methods are used. The AP scanning methods include an active scanning method and a passive scanning method. The active scanning method is illustrated in FIG. 2, and is used in the WLAN environment of an infrastructure mode.

Referring to FIG. 2, the MS 10, which has moved from the network of the first AP 11 to the network of the second AP 12, transmits a probe request signal through a channel 1 in order to find an AP. The probe request signal is not transmitted to a particular AP. Instead, the probe request signal is transmitted to many unspecified APs so as to check whether a channel is occupied by an AP.

In this case, a channel is represented by a bandwidth whereby an AP can communicate with the MS 10 included in a network managed by the AP itself.

The channel is arbitrarily set for each AP. Generally, thirteen channels are used by an AP. In FIG. 2, for example, communication between the second AP 12 and the MS 10 is achieved through a channel 9.

Due to the arbitrary setting for each AP, after the MS 10 moves to the network of the second AP 12, the MS 10 cannot recognize which channel is used by the second AP 12. Thus, the MS 10 has to scan each AP starting from the channel 1.

The MS 10, which has moved to the network of the second AP 12, transmits the probe request signal through the channel 1. If the second AP 12 does not use the channel 1, the probe request signal cannot be received from the MS 10. Thus, a probe response signal cannot be transmitted to the MS 10, either. The MS 10 waits for the probe response signal for a predetermined length of time. If the probe response signal is not received, channel switching is performed by the MS 10 so that scanning can be performed through another channel. When the switching has finished, the probe request signal is transmitted through a channel 2. If the probe response signal is not received, the channel switching is performed. The MS 10 sequentially performs the same process with respect to up to a channel 8. After the second AP 12 transmits the probe response signal through the channel 9, authentication and association processes are carried out, and thus the communication with the second AP 12 is achieved.

In order to scan an AP after a handover is performed, that is, scan the second AP 12, a process of transmitting the probe request signal through each channel is repeated together with a waiting process and a switching process. Thus, a time delay occurring when the handover is performed mostly takes place in the AP scanning process.

If a handover to the second AP 12 is performed while data is being transmitted to and received from the first AP 11, the data cannot be transmitted/received for the same_length of time as a time delay. In particular, when data communication is achieved in which real-time based data transmission is crucial such as a voice over Internet protocol (VoIP), the time delay that occurs in the AP scanning process may cause significant degradation in a quality of service (QoS). Therefore, there is a need for a method that can reduce the time required for scanning an AP and thus minimize a time delay produced when a handover occurs.

### SUMMARY OF THE INVENTION

The present invention provides a method and apparatus capable of minimizing a time delay occurring in the process of scanning an access point used in data communication by a mobile station.

According to an aspect of the present invention, there is provided a handover method of a mobile station moving from a network of a first access point to a network of a second access point, the handover method comprising: scanning the second access point through a channel according to a handover history registered in the mobile station; and associating the mobile station with the second access point according to a result of the scanning.

In the aforementioned aspect of the present invention, the handover history may include information on the first access point in which a handover was previously performed, and channel information on an access point which is scanned after the handover is performed.

In addition, the information on the first access point may include an SSID or a BSSID of the first access point.

In addition, the channel information may include at least one of information on a number of handovers previously performed through the channel and information on a handover time.

In addition, the handover method may further comprise updating the handover history according to a result of performing a handover.

According to another aspect of the present invention, there is provided a handover apparatus of a mobile station moving from a network of a first access point to a network of a second access point, the handover apparatus comprising: a scanning unit that scans the second access point through a channel according to a handover history registered in the mobile station; and an associating unit that associates the mobile station with the second access point according to a result of the scanning.

In the aforementioned aspect of the present invention, the handover apparatus may further comprise a history updating unit that updates the handover history according to the result of performing the handover.

According to another aspect of the present invention, there is provided a computer readable recording medium storing a computer program for performing the handover method.

### BRIEF DESCRIPTION OF THE DRAWINGS

The above and other aspects of the present invention will become more apparent by describing in detail exemplary embodiments thereof with reference to the attached drawings in which:

FIG. 1 illustrates a handover scenario in a related art WLAN environment;

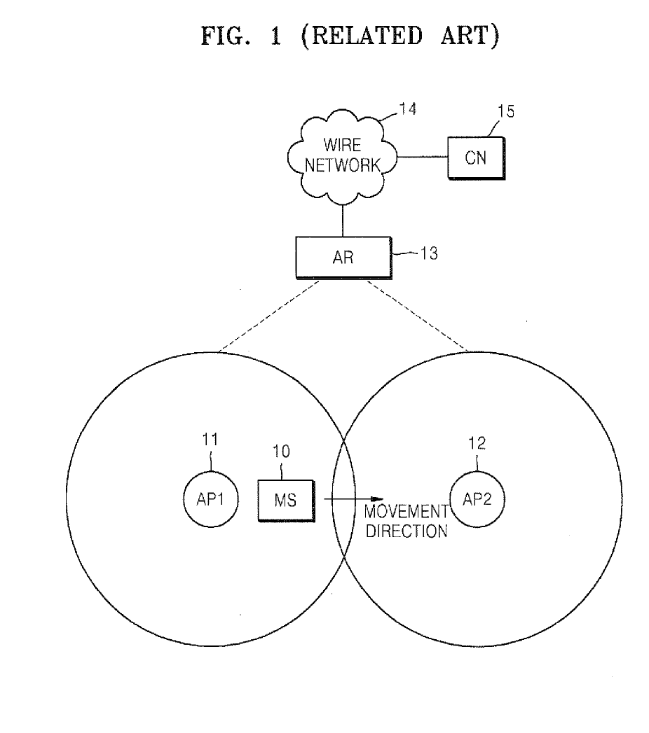

FIG. 2 illustrates a related art AP scanning method;

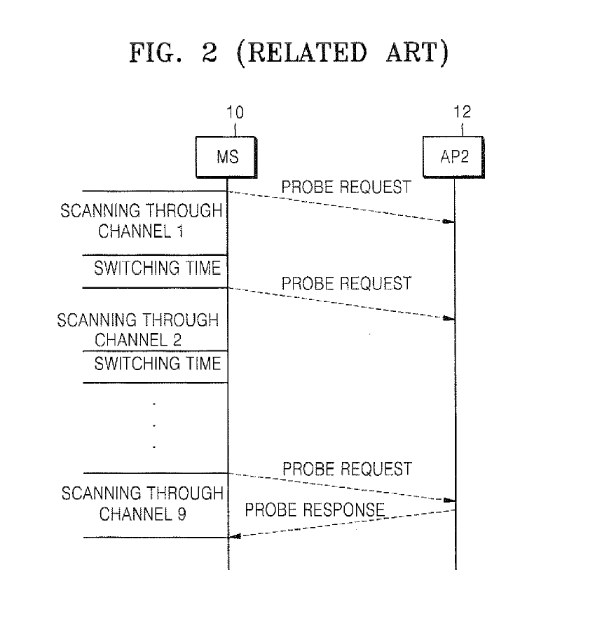

FIG. 3 illustrates a handover history according to an exemplary embodiment of the present invention;

FIG. 4 is a flowchart illustrating a handover method according to an exemplary embodiment of the present invention;

FIG. 5 is a flowchart illustrating a method of scanning an AP according to an exemplary embodiment of the present invention;

FIG. 6 is a flowchart illustrating a method of updating a handover history according to an exemplary embodiment of the present invention; and

FIG. 7 illustrates a handover apparatus according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

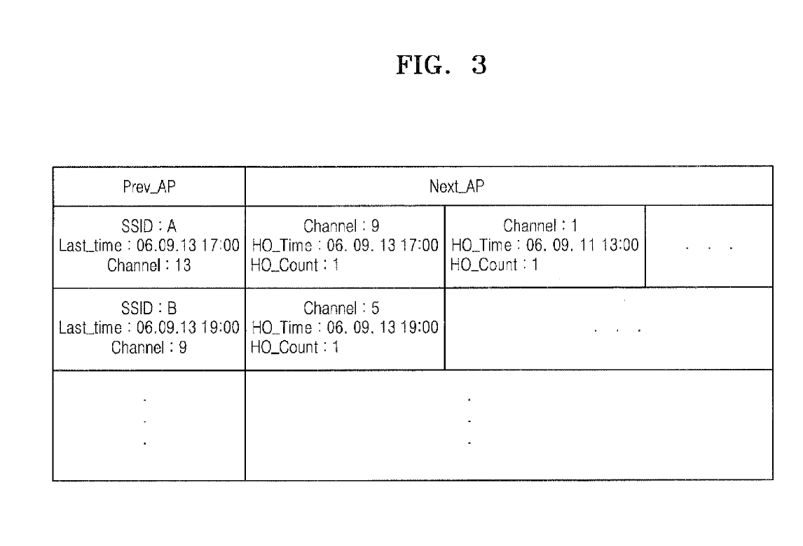

FIG. 3 illustrates a handover history according to an exemplary embodiment of the present invention.

Referring to FIG. 3, with regard to a handover that is previously performed by an MS, its handover history includes information on an AP before the handover is performed and channel information on an AP which is scanned after the handover is performed.

Specifically, FIG. 3 illustrates a handover history created when the handover is repeatedly performed for A, B, and C, in this order, where A, B, and C are respectively an SSID of a first AP 11, an SSID of a second AP 12, and an SSID of a third AP (not shown). A handover from the first AP 11 to the second AP 12 is first performed, and thereafter a handover from the second AP 12 to the third AP is performed.

With regard to a handover previously performed by an MS, Prev_AP information includes information on an AP before the handover is performed. The information on an AP includes information for identifying the AP. The information for identifying the AP may be an SSID or a BSSID.

Therefore, in FIG. 3, the Prev_AP information includes SSIDs for identifying the first AP 11 and the second AP 12. Instead of the SSIDs, a BSSID of the first AP 11 and a BSSID of the second AP 12 may be included to identify the first and the second APs 11 and 12.

In addition to the SSIDs or BSSIDs, the Pre_AP information also includes information on a last handover preformed in each AP. A Last_time parameter indicates information on a last handover time.

In order for the handover history to be searched quickly, the Last_time parameter may be used when an MS performs a handover. For example, when the MS searches the handover history so as to determine a pattern of a handover currently being performed, the Prev_AP information may be first searched to find an AP of which a Last_time parameter has the latest time, and thereafter the Next_AP information of the found AP may be searched.

The Last_time information may be used to maintain the handover history as the latest information. Since there is a limit in the size of a memory of the MS to store the handover history, after a predetermined time elapses from the last handover time, Prev_AP information and Next_AP information on the found AP may be deleted from the handover history, thereby maintaining the handover history as the latest information.

Besides the information mentioned above, the Prev_AP information may includes channel information used in the AP before the handover is performed.

The Next_AP information includes channel information on an AP which is to be scanned after the handover is performed. Since the present invention is related to a method and apparatus for further effectively performing AP scanning, the Next_AP information includes information on a channel through which the AP scanning has to be preferentially performed in a handover process.

In a first handover process, the MS moves from the first AP 11 to the second AP 12. Thus, if the second AP 12 is scanned through a channel 9, the Next_AP information includes information on the channel 9 and the Prev_AP information includes an SSID of A.

In a second handover process, the MS moves from the second AP 12 to the third AP. Thus, if the third AP is scanned through a channel 5, the Next_AP information includes information on the channel 5 and the Prev_AP includes an SSID of B.

It has been assumed above that handovers are repeatedly performed in the order of the first AP 1, the second AP 12, and the third AP. However, the MS does not always have to move from the first AP 11 to the second AP 12. Thus, the MS may occasionally move to another AP adjacent to the first AP 11.

Hence, the Next_AP information may include information on a plurality of channels. For example, if the MS moves from the first AP 11 to a fourth AP (not shown), and the fourth AP is scanned through a channel 1, the Next_AP information includes information on the channel 1 and the Prev_AP includes an SSID of A.

If the information on the channels is included in the Next_AP information, priority is given to the channels through which an AP has to be scanned. In this case, information on the number of handovers performed in the first AP through each channel or information on time is used. The higher the number of handovers performed through a particular channel, the higher the probability of scanning an AP through the channel. Thus, the probability of reducing a time for scanning the AP is also high. On the other hand, the later the handover time at a particular channel, the higher the probability of re-scanning the AP through the channel. Thus, the Next_AP information includes an HO_Count parameter that indicates the number of handovers performed through each channel and an HO_Time parameter that indicates the latest handover time.

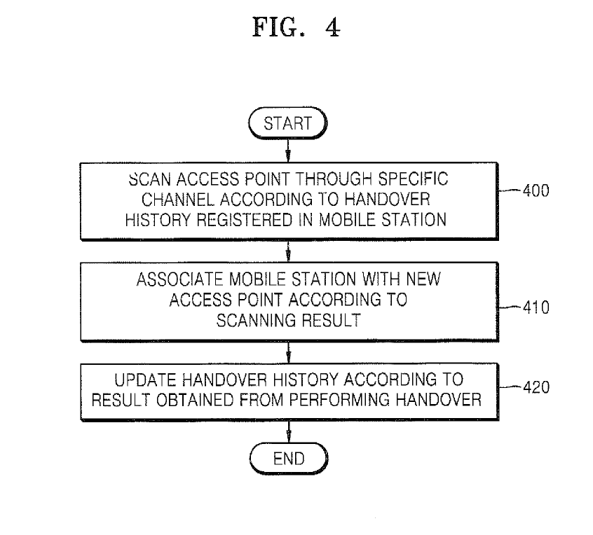

FIG. 4 is a flowchart illustrating a handover method according to an exemplary embodiment of the present invention.

Specifically, FIG. 4 is a flowchart illustrating a handover method used when an MS 10, in which a handover history similar to the one illustrated in FIG. 3 is stored, moves from the network of a first AP 11 to the network of a second AP 12. Referring to FIG. 4, in operation 400, the MS 10 that moves to the network of the second AP 12 scans the second AP 12 through a specific channel according to a previous handover history.

In general, a user who uses the MS 10 lives his or her life with a specific pattern. Accordingly, the movement of the MS 10 follows the pattern. For example, if the user uses a notebook computer through a WLAN on a commuter route, communication is made with APs related to the commuter route. A handover between APs also follows the pattern, as the MS 10 moves. The handover history mentioned above is used to scan an AP through a specific channel so that the pattern can be utilized.

It will be assumed that the second AP 12 is scanned according to the handover history of FIG. 3, and an SSID of the first AP 11 is A. In this case, the MS 10 searches the Prev_AP information in order to find an AP having an SSID of A. Thereafter, the MS 10 searches the Next_AP information regarding the found AP so as to obtain channel information, thereby scanning the AP.

In FIG. 3, in regard to the AP having an SSID of A, since its Next_AP information includes channel information in the order of the channel 9, the channel 1, etc., a probe request signal is first transmitted through the channel 9, thereby scanning the second AP 12. If the second AP 12 is not scanned through the channel 9, the probe request signal is transmitted through the channel 1 having a next priority, thereby scanning the second AP 12.

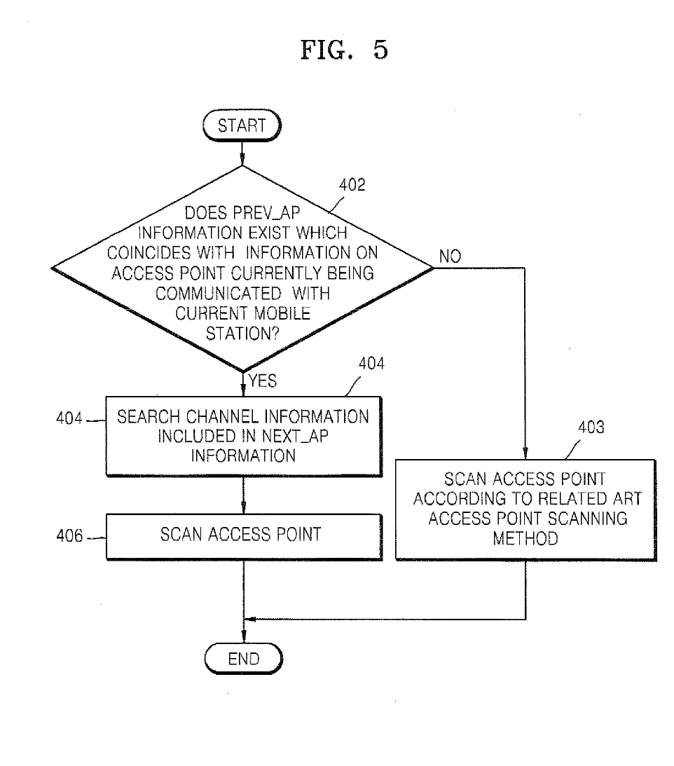

FIG. 5 is a flowchart illustrating a method of scanning an AP according to an exemplary embodiment of the present invention. In FIG. 5, operation 400 in FIG. 4 for scanning an AP is illustrated in greater detail.

In operation S402, the MS 10 determines the existence of Prev_AP information that coincides with information on the first AP 11 before a handover is performed, that is, the first AP 11 is currently being communicated with. An SSID or BSSID of the first AP 11 currently being communicated with is compared with an SSID or BSSID included in the Prev_AP information, thereby determining whether the Prev_AP information exists.

If the Prev_AP information that coincides with the information on the first AP 11 does not exist, in operation 403, the MS 10 scans the second AP 12 according to the related art AP scanning method. That is, a probe request signal is transmitted to each channel sequentially starting from the channel 1. If there is no probe response signal, the probe request signal is transmitted through another channel, thereby scanning the second AP 12.

If the Prev_AP information that coincides with the information on the first AP 11 exists, in operation 404, the MS 10 searches channel information included in the Next_AP information on the first AP 11. Referring to the handover history of FIG. 3, there is Prev_AP information that coincides with information on the first AP 11 having an SSID of A. Thus, information on the channel 9, the channel 1, etc. is searched.

In operation 406, the MS 10 scans the second AP 12 through a specific channel according to the channel information found in operation 404. That is, a probe request signal is first transmitted through the channel 9 according to the priority, based on the search in operation 404. If no probe response signal is received, the probe request signal is transmitted through the channel 1, thereby scanning the second AP 12. If no probe response signal is received after the probe request signal is transmitted according to all channel information included in the Next_AP information, the probe request signal is sequentially transmitted to the rest of the channels.

By performing operations 402 to 406, the MS 10 minimizes a time delay that occurs in the AP scanning by using the handover history in which a specific handover pattern is recorded.

Referring back to FIG. 4, in operation 410, the MS 10 is associated with the second AP 12 that has been scanned in operation 400. The MS 10 is associated with the second AP 12 that has transmitted a probe response signal in response to the probe request signal transmitted by the MS 10 in an authentication process. The authentication and association processes in the WLAN environment conform to the IEEE 802.11 standard, and will be easily understood by those of ordinary skill in the art. Thus, detailed descriptions thereof will be omitted.

In operation 420, the handover history is updated according to the result obtained by performing the handover by performing operations 400 and 410.

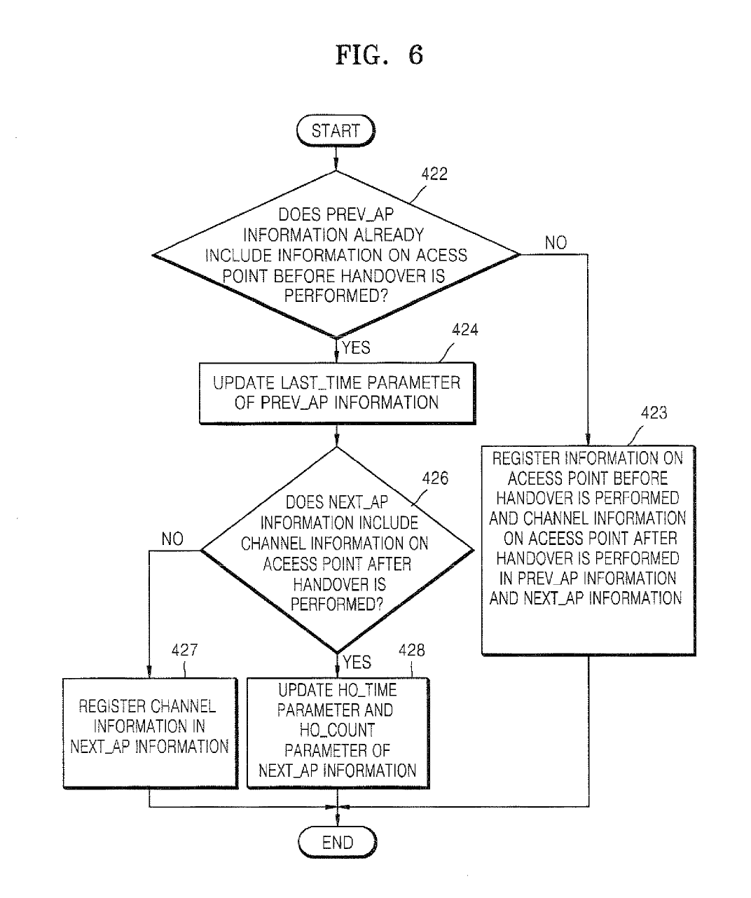

FIG. 6 is a flowchart illustrating a method of updating a handover history according to an exemplary embodiment of the present invention. Operation 420, illustrated in FIG. 4, for updating a history handover is illustrated in greater detail in FIG. 6.

Referring to FIG. 6, in operation 422, the MS 10 determines whether the Prev_AP information of the handover history already includes information on an AP before a handover is performed. In this operation, before the handover is performed, the AP is the first AP 1. The AP scanning in operation 400 may be performed on the basis of the handover pattern stored in the handover history. However, if the information on the first AP 11 does not exist in the handover history, as described with reference to operation 403, the AP scanning is performed according to the related art AP scanning method.

In this case, after the handover is completely performed by means of the scanning, authentication, and association processes, the information on the first AP 11 needs to be registered in the handover history according to the result obtained from performing the handover. Thus, in operation 422, it is determined whether the Prev_AP information of a handover history already includes information on the AP before the handover is performed.

In operation 423, the MS 10 registers information on the AP before the handover is performed and channel information on an AP after the handover is performed in the Prev_AP information and the Next_AP information, respectively. In other words, if the determination result in operation 422 shows that the information on the first AP 11 does not exist in the Prev_AP information, in operation 423, the MS 10 registers the information on the first AP 11 in the Prev_AP information, and registers the channel information on a channel, through which the second AP 12 is scanned, in the Next_AP information. In this operation, a Last_time parameter of the Prev_AP information, an HO_Time parameter of the Next_AP information, and an HO_Count parameter of the Next_AP information are registered as well.

If the Prev_AP information already includes the information on the first AP 11 in operation 422, the MS 10 updates the Last_time parameter of the Prev_AP information in operation 424. In this case, the information on the first AP 11 does not have to be registered again. Instead, only the Last_time parameter that indicates a last handover time is updated to the latest information.

In operation 426, the MS 10 determines whether the Next_AP information of the handover history includes the channel information on an AP after the handover is performed. In this operation, after the handover is performed, the AP is the second AP 12.

In operation 427, the MS 10 registers the channel information on the second AP 12 in the Next_AP information of the handover history. Although the Prev_AP information includes the information on the first AP 11, in some cases, the Next_AP information may not include the channel information on the second AP since a handover from the first AP 11 to the second AP 12 has never been performed. Thus, if the determination result of operation 426 shows that the Next_AP information does not include the channel information on the second AP 12, the MS 10 registers the channel information on the second AP 12 in the Next_AP information on the second AP 12 that includes the information on the first AP 11.

If the determination result of operation 426 shows that the channel information on the second AP 11 is already included, the MS 10 updates the HO_Time parameter and HO_Count parameter of the Next_AP information in operation 428. In this case, the information on the second AP 12 does not have to be registered again. Instead, the HO_Time parameter that indicates a handover time is updated to the latest information, and the HO_Count parameter that indicates the number of handovers performed is incremented by 1.

A process of deleting a handover history that has not been used for a long time may be included in operations 422 to 428. In the updating process mentioned above, the information that has not been used for a long time may be deleted from the handover history on the basis of information included in the Last_time parameter of the Prev_AP information or the HO_Time parameter of the Next_AP information.

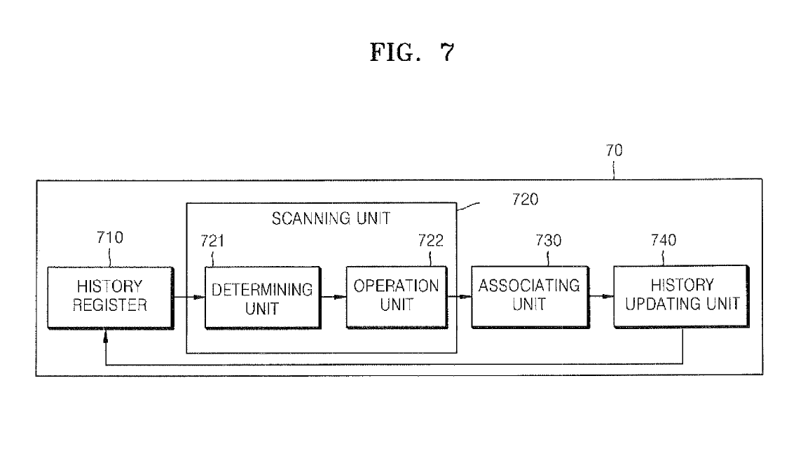

FIG. 7 illustrates a handover apparatus according to an exemplary embodiment of the present invention.

The handover apparatus 70 of this exemplary embodiment includes a history register 710, a scanning unit 720, an associating unit 730, and a history updating unit 740. The scanning unit 720 may include a determining unit 721 and an operation unit 722.

The history register 710 registers a history of handovers previously performed by an MS. As shown in FIG. 3, the handover history includes a Prev_AP information containing information on an AP before a handover is performed and a Next_AP information containing channel information on an AP after the handover is performed.

The Prev_AP information includes an SSID or BSSID for identifying an AP. Furthermore, the Prev_AP information also includes a Last_time parameter that indicates a last handover time and channel information on the AP.

The Next_AP information includes channel information on channels through which the AP has been scanned in a previous handover process. Furthermore, the Next_AP information includes a HO_Time parameter that indicates a handover time and a HO_Count parameter that indicates the number of handovers performed.

The Next_AP information may include information on a plurality of channels each having a priority determined according to the number of handovers or the handover time.

The scanning unit 720 scans the AP through a specific channel according to the handover history registered in the history register 710. The handover history includes information on a handover pattern for a previously performed handover. Thus, according to the channel information included in the Next_AP information of the handover history, a probe request signal is transmitted through the specific channel and receives a probe response signal, thereby scanning the AP.

The determining unit 721 determines the existence of the Prev_AP information of the handover history, where the Prev_AP information coincides with the information on an AP before the handover is performed. An SSID or BSSID of the AP currently being communicated is compared with an SSID or BSSID included in the Prev_AP information, thereby determining the existence of the Prev_AP information.

According to the determination result of the determining unit 721, the operation unit 722 scans an AP that will communicate with an MS after the handover is performed. If the determining unit 721 confirms the existence of the Prev_AP information that coincides with the SSID or BSSID of an AP currently being communicated with, the AP of the specific channel is first scanned according to the handover history. If the determining unit 721 confirms that there is no Prev_AP information that coincides with the SSID or BSSID of the AP currently being communicated with, the AP is scanned according to the related art AP scanning method.

The associating unit 730 associates an MS with an AP scanned by the scanning unit 720. Specifically, the association unit 730 associates an MS with an AP that has transmitted the probe response signal in response to the probe request signal transmitted from the MS.

The history updating unit 740 updates the handover history according to the result of a handover performed by the scanning unit 720 and the associating unit 730. With regard to the handover currently being performed, if the handover history does not include information on an AP before the handover is performed and channel information on an AP after the handover is performed, the handover history is updated. If the information and channel information mentioned above are already included, the last handover time and the number of handovers which are registered in the information is updated to the latest information.

According to exemplary embodiments of the present invention, a pattern of a previously performed handover is registered in a handover history, so that the pattern is used to scan a specific channel, thereby minimizing a time delay occurring in the process of scanning an AP. With the minimized time delay, it is possible to avoid data loss in real-time based data communication such as VoIP.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A handover method of a mobile station moving from a network of a first access point to a network of a second access point, the handover method comprising:
scanning the second access point through a channel according to a handover history registered in the mobile station; and
associating the mobile station with the second access point according to a result of the scanning.

2. The handover method of claim 1, wherein the handover history comprises information on the first access point in which a handover was previously performed, and channel information on an access point which is scanned after the handover is performed.

3. The handover method of claim 2, wherein the information on the first access point includes a service set identifier or a basic service set identifier of the first access point.

4. The handover method of claim 2, wherein the information on the first access point includes information on a last handover time for the handover previously performed in the first access point.

5. The handover method of claim 2, wherein the channel information comprises at least one of information on a number of handovers previously performed through the channel and information on a handover time.

6. The handover method of claim 5, wherein the channel information comprises information on a plurality of channels each of which has a priority determined according to the information on the number of handovers or the information on the handover time.

7. The handover method of claim 1, further comprising updating the handover history according to a result of performing a handover.

8. The handover method of claim 7, wherein the updating comprises updating at least one of information on a last handover time for a handover previously performed in the first access point and information on the channel.

9. The handover method of claim 1, wherein the access point and the mobile station are a wireless local area network (WLAN) access point and a WLAN mobile station, respectively, which communicate in compliance with IEEE 802.11.

10. A handover apparatus of a mobile station moving from a network of a first access point to a network of a second access point, the handover apparatus comprising:
a scanning unit that scans the second access point through a channel according to a handover history registered in the mobile station; and
an associating unit that associates the mobile station with the second access point according to a result of the scanning.

11. The handover apparatus of claim 10, wherein the handover history comprises information on the first access point in which a handover was previously performed, and channel information on an access point which is scanned after the handover is performed.

12. The handover apparatus of claim 11, wherein the information on the first access point includes a service set identifier or a basic service set identifier of the first access point.

13. The handover apparatus of claim 11, wherein the information on the first access point includes information on a last handover time for the handover previously performed in the first access point.

14. The handover apparatus of claim 11, wherein the channel information comprises at least one of information on a number of handovers previously performed through the channel and information on a handover time.

15. The handover apparatus of claim 14, wherein the channel information comprises information on a plurality of channels each of which has a priority determined according to the information on the number of handovers or the information on the handover time.

16. The handover apparatus of claim 10, further comprising a history updating unit that updates the handover history according to a result of performing a handover.

17. The handover apparatus of claim 16, wherein the history updating unit updates at least one of information on a last handover time for a handover previously performed in the first access point and information on the channel.

18. The handover apparatus of claim 10, wherein the access point and the mobile station are a wireless local area network (WLAN) access point and a WLAN mobile station, respectively, which communicate in compliance with IEEE 802.11.

19. A computer readable recording medium storing a computer program for performing a handover method of a mobile station moving from a network of a first access point to a network of a second access point, the handover method comprising:
scanning the second access point through a channel according to a handover history registered in the mobile station; and
associating the mobile station with the second access point according to a result of the scanning.
